(19) United States
(12) Patent Application Publication
(10) Pub. No.: US 2021/0389920 A1
(43) Pub. Date: Dec. 16, 2021

(54) CONTROL METHOD AND APPARATUS FOR DISPLAYING WIDGET

(71) Applicant: BEIJING DAJIA INTERNET INFORMATION TECHNOLOGY CO., LTD., Beijing (CN)

(72) Inventors: Yiwen Zhang, Beijing (CN); Chao Zhu, Beijing (CN); Jing Zhou, Beijing (CN)

(21) Appl. No.: 17/137,493

(22) Filed: Dec. 30, 2020

(30) Foreign Application Priority Data
Jun. 15, 2020 (CN) 202010544448.5

(51) Int. Cl. G06F 3/14; G06T 11/00; G06F 9/451

(52) U.S. Cl. CPC G06F 3/14; G06F 9/451; G06T 11/00

(57) ABSTRACT

Embodiments of the disclosure disclose a control method and apparatus for displaying a widget, a system, an electronic device, a server and a storage medium. The method includes: acquiring a displaying control parameter of a widget on a page, generating content of the widget based on a state parameter of a displaying state in response to detecting a current time reaches an effective time of the displaying state, and displaying the widget whose state is updated to the displaying state based on the content of the widget.

### CROSS REFERENCE TO RELATED APPLICATIONS

The present application is based on and claim priority under 35 U.S.C. § 119 to Chinese Application No. 202010544448.5, filed with the China National Intellectual Property Administration on Jun. 15, 2020, the entire content of which is incorporated herein by reference.

### FIELD

The present disclosure relates to computer technologies, and particularly, to a control method and a control apparatus for displaying a widget, a system, an electronic device and a storage medium.

### BACKGROUND

Widgets are functionalities of an application which are often used. During running of the application, a widget can be displayed on a page of the application, and specific information can be displayed through the web widget, for example, notification information or advertisement information, which can be used as a shortcut entrance that makes it easier for a user to quickly enter into a corresponding page.

At present, the widgets, as controls displayed on a page of the application, are often specifically developed and displayed according to different displaying requirements, such that it usually takes a great effort to develop the widgets for an application scenario having huge different displaying requirements or frequently changed displaying requirements. Thus, the development of widgets cannot meet application requirements in real time.

### SUMMARY

The disclosure provides a control method and a control apparatus for displaying a widget, a system, an electronic and a storage medium, to at least solve a problem that a development of widgets takes a great effort for an application scenario having huge different displaying requirements or frequently changed displaying requirements, which cannot meet application requirements in real time.

Accordingly, embodiments of a first aspect of the present disclosure provide a control method for displaying a widget. The method includes: acquiring a displaying control parameter of a widget on a page, the displaying control parameter including a state parameter of a displaying state, and an effective time corresponding to the displaying state; generating content of the widget according to the state parameter of the displaying state in response to detecting a current time reaches the effective time corresponding to the displaying state; and displaying the widget having a state updated to the displaying state according to the content of the widget.

Embodiments of a second aspect of the present disclosure provide a control method for displaying a widget. The method includes: receiving a first request to acquire a displaying control parameter from an electronic device, the first request including a widget identification of a widget; determining the displaying control parameter of the widget according to the widget identification, the displaying control parameter including a state parameter of a displaying state, and an effective time corresponding to the displaying state; and sending the displaying control parameter to the electronic device.

Embodiments of a third aspect of the present disclosure provide a control apparatus for displaying a widget. The apparatus includes: an acquiring module, a detecting module and a displaying module. The acquiring module is configured to acquire a displaying control parameter of a widget on a page, the displaying control parameter including a state parameter of a displaying state, and an effective time corresponding to the displaying state. The detecting module is configured to generate content of the widget according to the state parameter of the displaying state in response to detecting a current time reaches the effective time corresponding to the displaying state. The displaying module is configured to display the widget having a state updated to the displaying state according to the content of the widget.

Embodiments of a fourth aspect of the present disclosure provide a control apparatus for displaying a widget. The apparatus includes: a receiving module, a determining module and a sending module. The receiving module is configured to receive a first request to acquire a displaying control parameter from an electronic device, the first request including a widget identification of a widget. The determining module is configured to determine the displaying control parameter of the widget according to the widget identification, the displaying control parameter including a state parameter of a displaying state, and an effective time corresponding to the displaying state. The sending module is configured to send the displaying control parameter to the electronic device.

Embodiments of a fifth aspect of the present disclosure provide an electronic device. The electronic device includes one or more processors and one or more memories. The one or more memories are configured to store instructions executable by the one or more processors; the one or more processors are configured to execute the instructions to implement the control method for displaying a widget as described in any implementation of the embodiments of the first aspect.

Embodiments of a sixth aspect of the present disclosure provide a server. The server includes one or more processors and one or more memories. The one or more memories are configured to store instructions executable by the one or more processors; the one or more processors are configured to execute the instructions to implement the control method for displaying a widget as described in any implementation of the embodiments of the second aspect.

Embodiments of a seventh aspect of the present disclosure provide a system for displaying a widget. The system includes an electronic device as described in embodiments of the fifth aspect and a server as described in embodiments of the sixth aspect.

Embodiments of an eighth aspect of the present disclosure provide a non-transitory computer-readable storage medium including instructions that, when executed by one or more processors of an electronic device, cause the electronic device to perform the control method for displaying a widget as described in any implementation of the embodiments of the first aspect, or when executed by one or more processors of a server, cause the server to perform the control method for displaying a widget as described in any implementation of the embodiments of the second aspect.

Embodiments of a ninth aspect of the present disclosure provide a computer program product, when the computer program product runs on a server, causes the server to perform the control method for displaying a widget as described in any implementation of the embodiments of the first aspect; or when instructions in the computer program product are executed by one or more processors of a server, causes the server to perform the control method for displaying a widget as described in any implementation of the embodiments of the second aspect.

### BRIEF DESCRIPTION OF THE DRAWINGS

To illustrate the solutions according to the embodiments of the present disclosure or in the prior art more clearly, accompanying drawings needed for describing the embodiments or the prior art are briefly introduced below. Obviously, the accompanying drawings in the following descriptions are merely some embodiments of the present disclosure, and persons of ordinary skill in the art may obtain other drawings according to the accompanying drawings without making creative efforts.

FIG. 1 is a flow chart illustrating a control method for displaying a widget according to an exemplary embodiment.

FIG. 2 is a flow chart illustrating a control method for displaying a widget according to another exemplary embodiment.

FIG. 3 is a schematic diagram illustrating a signaling interaction of a control method for displaying a widget according to an exemplary embodiment.

FIG. 4 is a block diagram illustrating a control apparatus for displaying a widget according to an exemplary embodiment.

FIG. 5 is a block diagram illustrating a control apparatus for displaying a widget according to another exemplary embodiment.

FIG. 6 is a block diagram illustrating a control system for displaying a widget according to an exemplary embodiment.

FIG. 7 is a block diagram illustrating an electronic device according to an exemplary embodiment.

FIG. 8 is a block diagram illustrating a control apparatus for displaying a widget according to a still exemplary embodiment.

### DETAILED DESCRIPTION

In order to make the technical solution of the present disclosure better understood, the technical solution in embodiments of the present disclosure will be clearly and completely described below with reference to the accompanying drawings. Obviously, the described embodiments are merely part of rather than all of the embodiments of the present disclosure. All other embodiments obtained by persons of ordinary skill in the art based on the embodiments of the present disclosure shall fall within the protection scope of the present disclosure.

The technical solution of embodiments of the present disclosure will be described with reference to the drawings in the embodiments.

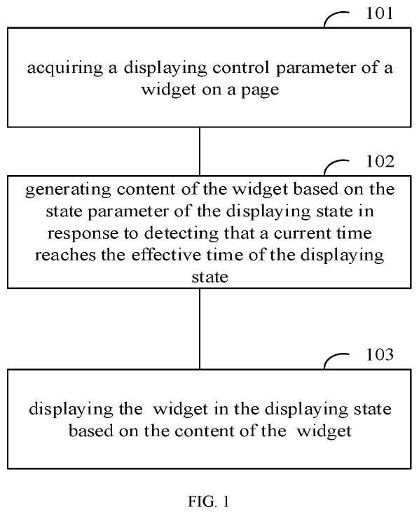

FIG. 1 is a flow chart illustrating a method for displaying a widget according to an exemplary embodiment. As illustrated in FIG. 1, the method can be applicable to adjust the widget in an application, so as to adjust a displaying state of the widget flexibly and quickly. The method can be performed by a control apparatus for displaying a widget, which may be implemented in software and/or hardware. The apparatus can be disposed in an electronic device, and the method includes followings.

In block 101, a displaying control parameter of a widget in a page is acquired.

The displaying control parameter includes a state parameter of a displaying state, and an effective time corresponding to the displaying state.

In this embodiment, the page is a page of an application which is currently displayed on a display screen of the electronic device. The page may include one or more widgets and the widget may be some or all of the widgets in the page. The electronic device may acquire the displaying control parameter of each widget in the page, or may acquire the displaying control parameters of some widgets in the page. In order to easily understand, this embodiment will be described by taking one widget as an example.

The displaying control parameter may include state parameters of one or more displaying states, and an effective time corresponding to each displaying state. For example, the displaying control parameter includes a state parameter of displaying state A and a corresponding effective time, a state parameter of displaying state B and a corresponding effective time, and a state parameter of displaying state C and a corresponding effective time. The number of the displaying states can be set according to actual needs, which is not limited herein.

In this embodiment, the state parameter is used to adjust a displaying state of the widget. The electronic device may display the widget in different displaying states according to the state parameters corresponding respectively to the displaying the states. For example, if the state parameter of the displaying state A includes image A, the state parameter of the displaying state B includes image B, and the state parameter of the displaying state C includes image C, then the electronic device may display the widget having the state updated to the displaying state A according to the image A, display the widget having the state updated to the displaying state B according to the image B, and display the widget having the state updated to the displaying state C according to the image C. The widget in the displaying state A, the widget in the displaying state B and the widget in the displaying state C display different images, respectively. Thus, the widget in the displaying state A, the widget in the displaying state B and the widget in the displaying state C present different states. The detail content of the state parameter can be set according to actual needs, which is not limited herein.

Different displaying states correspond to different effective time. The electronic device may control the widget to be displayed in different displaying states at different effective time. For example, the effective time may include an effectiveness starting time. If the effectiveness starting time of the displaying state A is March 18, 10 am, the effectiveness starting time of the displaying state B is March 18, 1 pm, the effectiveness starting time of the displaying state C is March 18, 2 pm, then the electronic device may display the widget having the state updated to the displaying state A from March 18, 10 am, display the widget having the state updated to the displaying state B from March 18, 1 pm, and display the widget having the state updated to the displaying state C from March 18, 2 pm according to the effectiveness starting time corresponding to the displaying states, respectively.

In some embodiments, the electronic device may send a request to a server directly, to obtain the displaying control parameter returned by the server in response to the request. Alternatively, the electronic device may receive the displaying control parameter sent by the server directly. Alternatively, the electronic device may acquire the displaying control parameter stored in advance, or acquire the displaying control parameter from other electronic devices. The method of acquiring the displaying control parameter by the electronic device may be set according to actual needs, which is not limited herein.

In block 102, content of the widget to be displayed is generated according to the state parameter of the displaying state in response to detecting that a current time reaches the effective time of the displaying state.

In some embodiments, after acquiring the displaying control parameter of the widget, the electronic device may determine whether to update the displaying state of the widget according to the effective time corresponding to the displaying state. When it is determined that the current time reaches the effective time corresponding to one displaying state, the electronic device firstly generate the content of the widget according to the state parameter of the displaying state.

In combination with the above examples, the electronic device may determine that the current time reaches the effective time of the displaying state A in response to detecting that the central processing unit (CPU) time is March 18, 10 am, then the electronic device may determine the image A from the state parameter of the displaying state A and take the image A as the content of the widget in the displaying state A. Similarly, if the CPU time of March 18, 1 pm is detected, the electronic device may determine the image B from the state parameter of the displaying state B and take the image B as the content of the widget in the displaying state B. If the CPU time of March 18, 2 pm is detected, the electronic device may determine the image C from the state parameter of the displaying state C and take the image C as the content of the widget in the displaying state C. It should be noted that the above description is merely exemplary. When the state parameter contains different parameters, different methods of generating the content of the widget will be adopted. The specific method of generating the content of the widget may be set according to actual needs, which is not limited herein.

In block 103, the widget in the displaying state is displayed according to the content of the widget.

In some embodiments, at the effective time of the widget, the electronic device may display the widget having a state updated to the displaying state according to the generated content of the widget to be displayed.

In combination with the above examples, after the content (image A) of the widget corresponding to the displaying state A, the electronic device may render the image A and display the rendered image A in the displaying page of the widget, so as to update the displaying state of the widget to the displaying state A. Similarly, at March 18, 1 pm, the displaying state of the widget is updated to the displaying state B, and at March 18, 2 pm, the displaying state of the widget is updated to the displaying state C.

In summary, in the embodiment, the displaying control parameter of the widget on the page is acquired, the content of the widget is generated according to the state parameter of the displaying state in response to detecting that the current time reaches the effective time of the displaying state, and the widget having the state updated to the displaying state is displayed according the content of the widget. The electronic device may update the displaying state of the widget according to the state parameter of the displaying state at the corresponding effective time. In this way, it is unnecessary to re-develop the widgets, and different displaying requirements can be met by flexibly controlling the displayed content of the widget, such that an efficiency of displaying the widget can be improved, in particularly adaptable to the application scenario having huge different displaying requirements or frequently changed displaying requirements.

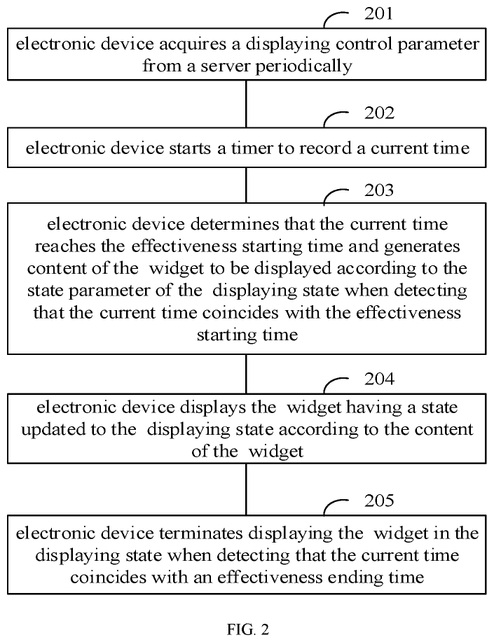

FIG. 2 is a flow chart illustrating a control method for displaying a widget according to another embodiment of the present disclosure. As illustrated in FIG. 2, the method may include the followings.

In block 201, an electronic device acquires a displaying control parameter from a server periodically.

In some embodiments, the electronic device may send a request to the server at a preset interval, and the request may include a widget identification of a widget (for example a name of the widget in an application). The server may parse the request after receiving the request from the electronic device, determine the displaying control parameter of the widget according to the widget identification included in the request, and return the displaying control parameter to the electronic device. The preset interval may be 1 second, 2 seconds, or 3 seconds, which may be set according to actual needs, and not limited herein.

Alternatively, action in block 201 can be implemented as follows.

A version number of the displaying control parameter is acquired from the server periodically.

In a case that the version number currently acquired is different from a version number acquired last time, the displaying control parameter is acquired from the server.

The version number is used to uniquely identify the version of the displaying control parameter. In an actual application, once a user adjusts the widget in the application, the corresponding displaying control parameter can be set and a unique version number can be set for the adjusted displaying control parameter. A form of the version number can be set according to actual needs, which is not limited herein.

In some embodiments, before the electronic device acquires the displaying control parameter from the server, the electronic device may firstly acquire the version number of the displaying control parameter from the server. After acquiring the version number of the displaying control parameter, the electronic device may compare the currently acquired version number with the version number acquired last time, if the currently acquired version number is different from the version number acquired last time, then it indicates that the displaying control parameter in the server is new. In this case, the request can be sent to the server to acquire the new displaying control parameter from the server, and the widget in the page can be adjusted based on the new displaying control parameter. Instead, if the currently acquired version number is the same as the version number acquired last time, it indicates that the displaying control parameter in the server has been acquired by the electronic device, such that it is unnecessary for the electronic device to acquire the same displaying control parameter again from the server.

In an actual application, the electronic device acquires the displaying control parameter from the server at a preset interval, so that the new displaying control parameter may be acquired in time and the displaying state of the widget can be adjusted in time. During acquisition of the displaying control parameter, by determining whether to acquire the displaying control parameter according to the version number of the displaying control parameter, it can be avoided that the same displaying control parameter is acquired from the server repeatedly, such that a commutation load of the electronic device can be reduced.

Alternatively, the electronic device may send the request to acquire the version number of the displaying control parameter every time the application is launched.

For example, the electronic device may send the request to acquire the version number of the displaying control parameter when the application is launched by cold boot and/or hot boot. Every time the application is launched, the version number of the displaying control parameter is acquired from the server, such that the new displaying control parameter can be acquired from the server in time and the displaying state of the widget in the page can be adjusted according to the new displaying control parameter, so as to meet the real-time requirement. Regarding the meanings of cold boot and hot boot and a process of sending the request to the server by the electronic device when the application is launched, reference can be made to the related art, which are not explained herein.

The above description is merely exemplary, in an actual application, the version number of the displaying control parameter can be acquired in other ways, for example the electronic device may acquire the version number of the displaying control parameter from the server at the same when interface data is acquired from the server. The specific method of acquiring the version number of the displaying control parameter from the server can be set according to actual needs, which is not limited herein.

In some embodiments, the electronic device may acquire the displaying control parameter from the server via the content delivery network (CDN). In detail, the displaying control parameter may be stored in many nodes of the CDN, and the electronic device may acquire the displaying control parameter from the nodes of the CDN to reduce the load of the server. Regarding the specific process of acquiring the displaying control parameter via CDN, reference can be made to the processing of acquiring data via CDN in the related art, which is not explained herein.

In 202, the electronic device starts a timer to record a current time.

In some embodiments, the effective time includes an effectiveness starting time. The effectiveness starting time refers to the time when the displaying state begins to be displayed. That is, when the effectiveness starting time is up, the widget is displayed in the corresponding displaying state. When the user adjusts the displaying state of the widget, different effectiveness starting time can be set for different displaying states, such that different states of the widget are displayed at different time.

In combination with the above examples, the displaying state A, the displaying state B and the displaying state C correspond to different effectiveness starting time. After acquiring the displaying control parameter, the electronic device may determine the effectiveness starting time of each displaying state in the displaying control parameter and start the timer to record the current time according to the effectiveness starting time closest to the current time. For example, after the electronic device determines the effectiveness starting time (March 18, 10 am) corresponding to the displaying state A, the effectiveness starting time (March 18, 1 pm) corresponding to the displaying state B, and the effectiveness starting time (March 18, 2 pm) corresponding to the displaying state C, the electronic device may determine the effectiveness starting time closest to the current time (i.e., the effectiveness starting time corresponding to the displaying state A) and start the timer to record the current time according to the effectiveness starting time corresponding to the displaying state A.

In detail, the electronic device may set the timer and start the timer according to the server time and the CPU time of the electronic device. For example, if the electronic device acquires the server time of March 18, 0 am from the server and determines the CUP time of March 18, 1 am currently, then the server may determine the actual current time as March 18, 1 am (i.e., a sum of the server time and the CPU time) and determine that the effectiveness starting time of March 18, 10 am of the displaying state A is up in nine hours (time interval between the actual current time and the effectiveness starting time) starting from the current time. At this time, the electronic device may establish a process (timer) corresponding to the displaying state A, and starts the timer. By setting the timer according to the server time and the CPU time, the actual current time can be determined accurately, such that the displaying time of the displaying state can be controlled accurately.

In an actual application, the electronic device may read the CPU time of the electronic device directly, set and start the timer to record the current time according to the CPU time and the effectiveness starting time of the displaying state. For example, the electronic device may directly determine the CPU time (such as March 18, 1 am) of the electronic device after determining the effectiveness starting time of the displaying state A which is closest to the current time, and determine that the effectiveness starting time (March 18, 10 am) of the displaying state A is up in nine hours (time interval between the actual current time and the effectiveness starting time) starting from the current time. Regarding the meanings of the server time and the CPU time, reference can be made to the related art, which is not described herein.

In block 203, the electronic device determines that the current time reaches the effectiveness starting time and generates content of the widget to be displayed according to the state parameter of the displaying state when detecting that the current time coincides with the effectiveness starting time.

In some embodiments, when the electronic device detects that the current time coincides with the effectiveness starting time, the electronic device may generate the content of the widget according to the state parameter of the displaying state. In combination with action in block 202, the electronic device may detect the current time recorded by the timer to determine whether the current time reaches the effectiveness starting time after setting and starting the timer. For example, when the current time recorded by the timer is March 18, 10 am, it can be determined that the current time reaches the effectiveness starting time of the displaying state A. At this time, the electronic device may generate the content of the widget to be displayed according to the state parameter of the displaying state A.

Alternatively, the state parameter may include an image and/or a group of images corresponding to the displaying state. The content of the widget to be displayed can be generated according to the state parameter of the displaying state as follows.

The image and/or the group of images is/are determined from the state parameter of the displaying state as the content of the widget.

In some embodiments, the state parameter of the displaying state may directly include the image and/or the group of images (which may include multiple images, for example twenty images). When the electronic device detects that the current time reaches the effectiveness starting time of the displaying state, the electronic device may directly determine the image and/or the group of images included in the state parameter of the displaying state from the obtained displaying control parameter. In combination with the above examples, when the electronic device determines that the current time reaches the effectiveness starting time March 18, 10 am of the displaying state A, if the state parameter of the displaying state A includes the image A, the electronic device may determine the image A from the state parameter of the displaying state A as the content of the widget. Similarly, if the state parameter of the displaying state A includes the group of images, the electronic device may determine the group of images from the state parameter of the displaying state A as the content of the widget.

In an actual application, the state parameter may include the image and/or the group of images, the electronic device may generate the content of the widget corresponding to the displaying state according to the image and/or the group of images included in the state parameter, such that the widget is updated to the widget in the displaying state according to the content of the widget, thus realizing adjustment of the displaying state of the widget.

Alternatively, the state parameter may include a resource address corresponding to the displaying state. The content of the widget to be displayed can be generated according to the state parameter of the displaying state as follows.

The image and/or the group of images corresponding to the displaying state is/are acquired according to the resource address as the content of the widget.

In some embodiments, the state parameter may include the resource address corresponding to the displaying state. When the electronic device detects that the current time reaches the effectiveness starting time of the displaying state, the electronic device may acquire an image and/or a group of images corresponding to the displaying state according to the resource address in the state parameter and take the acquired image and/or group of images as the content of the widget. The resource address may be for example a uniform resource location (URL) corresponding to the image and/or the group of images and the electronic device may acquire the image and/or the group of images according to the URL. In combination with the above examples, if the state parameter of the displaying state A in the displaying control parameter includes a URL corresponding to an image and/or a group of images, the electronic device may acquire the image and/or the group of images corresponding to the displaying state A according to the URL in the state parameter, and take the image and/or the group of images as the content of the widget to be displayed. The specific type of the resource address may be set according to actual needs. Regarding the method of acquiring the image and/or the group of images according to the resource address, reference can be made to the related art, which is not limited herein.

In an actual application, if the state parameter of the displaying state includes the resource address, the electronic device may acquire the image and/or the group of images corresponding to the displaying state according to the resource address after acquiring the displaying control parameter and before detecting that the current time reaches the effectiveness starting time of the displaying state. Accordingly, after detecting that the current time reaches the effectiveness starting time of the displaying state, the electronic device may directly generate the content of the widget to be displayed according to the acquired image and/or the acquired group of images included in the state parameter. By acquiring the image and/or the group of images before detecting that the current time reaches the effectiveness starting time of the displaying state, it may be avoided that the image and/or the group of images cannot acquired according to the resource address in time when it is detected that the current time reaches the effectiveness starting time of the displaying state, which may affect displaying of the displaying state.

Further, before detecting that the current time reaches the effectiveness starting time of the displaying state, the electronic device may acquire the image and/or the group of images flexibly according to a network condition and downloaded tasks. For example, the electronic device may determine whether to download the image and/or the group of images according to a type of connected network. For example, when the electronic device determines that the type of the connected network is wireless fidelity (Wi-Fi), the electronic device downloads the corresponding image and/or group of images according to the resource address. Alternatively, when the electronic device determines that the current downloaded tasks are few, the electronic device downloads the corresponding image and/or group of images according to the resource address. The specific process of acquire the image and/or the group of images according to the resource address can be set according to actual needs, which is not limited herein.

In the embodiment, the state parameter may include the resource address corresponding to the displaying state, and the electronic device may acquire the image and/or the group of images according to the resource address and generate the content of the widget to be displayed according to the acquired image and/or the acquired group of images, such that the displaying state of the widget can be adjusted according to the content of the widget. By including the resource address in the state parameter, the data amount of the displaying control parameter can be reduced, such that the electronic device may quickly and conveniently acquire the displaying control parameter.

In block 204, the electronic device displays the widget having a state updated to the displaying state according to the content of the widget.

In some embodiments, after detecting that the current time reaches the effectiveness starting time of the displaying state and generating the corresponding content of the widget, the electronic device may display the widget whose state is updated to the displaying state according to the content of the widget. In combination with the above examples, after detecting that the current time reaches the effectiveness starting time of the displaying state A and generating the corresponding content (the image and/or the group of images) of the widget corresponding to the displaying state A, the electronic device may display the widget whose state is updated to the displaying state A according to the content of the widget corresponding to the displaying state A.

Alternatively, the state parameter may further include a displaying identification.

When the electronic device determines that the image is to be displayed according to the displaying identification, the electronic device displays the widget in the displaying state according to the image.

In another example, when the electronic device determines that images in the group of images are to be displayed according to the displaying identification, the electronic device displays the widget in the displaying state according to the images in the group of images.

In combination with the above examples, the content of the widget can be the image and/or the group of images. When the content of the widget includes the image and the group of images, the electronic device may control the widget to display the image and the group of images according to the displaying identification. The displaying identification may be for example “0” and “1”. “0” indicates that the image is to be displayed. “1” indicates that the group of image is to be displayed. Before or after generating the content of the widget, the electronic device may determine the displaying identification in the state parameter. If the displaying identification is “0”, the electronic device may display the widget in the displaying state A according to the image in the content of the widget. If the displaying identification is “1”, the electronic device may display the widget in the displaying state A according to the group of images in the content of the widget. The specific form of the displaying identification can be set according to actual needs, which is not limited herein.

In the embodiment, the state parameter includes the displaying identification, and the electronic device may control the displaying mode of the widget according to the displaying identification, such that the widget can displayed with different displaying modes in different displaying states, thereby satisfying different displaying requirements of the page.

Alternatively, the state parameter may further include a height parameter and a width parameter of the widget.

Accordingly, the widget having the state updated to the displaying state can be displayed according to the image as follows.

The image is rendered and the rendered image is displayed in a displaying page of the widget according to the height parameter and the width parameter.

In some embodiments, the state parameter may include the height parameter and the width parameter corresponding to the displaying state. The electronic device may control the height and width of the widget according to the height parameter and the width parameter. In combination with the above examples, after generating the content (image A) of the widget in the displaying state A, the electronic device may render the image A and display the rendered image A in the displaying page of the widget according to the height parameter (for example 20 mm) and the width parameter (for example 30 mm). In the displaying page of the widget, the height of the rendered image A is 20 mm and the width of the rendered image A is 30 mm, i.e., the height of the widget is adjusted to 20 mm and the width of the widget is adjusted to 30 mm. Regarding the specific process of rendering and displaying the image, reference can be made to the related art, which is not explained herein.

In an actual application, assume that the image displayed in the displaying page of the widget has a height of 30 mm and a width of 40 mm before the displaying control parameter is acquired. After the displaying control parameter is acquired, the height of the image displayed in the displaying page of the widget may be adjusted to 20 mm and the width of the image may be adjusted to 30 mm, such that the adjustment of the height and width of the widget is realized.

Alternatively, the state parameter may further include a height parameter and a width parameter of the widget and a playing frame rate of the group of images.

Accordingly, the widget having the state updated to the displaying state can be displayed according to the images in the group of images as follows.

The images in the group of images are rendered and the rendered images are displayed based on the playing frame rate in sequence in a displaying page of the widget according to the height parameter and the width parameter.

In some embodiments, the state parameter may include the playing frame rate, and the electronic device may control the height and width of the widget according to the height parameter and the width parameter in the state parameter and control a playing rate of the animation in the displaying page of the widget according to the playing frame rate.

In combination with the above examples, if the content of the widget corresponding to the displaying state A includes the group of images, after displaying the group of images according to the displaying identification, the electronic device may render multiple images in the group of images and repeatedly play the multiple images according to the height parameter (for example 20 mm) and the width parameter (for example 30 mm) in the displaying page of the based on the playing frame rate (for example 22 frames per second), so as to display the widget in an animation manner. The number of images in the group of images and the playing frame rater can be set according to actual needs, which are not limited herein.

In the embodiment, the state parameter may include the height parameter, the width parameter and the playing frame rate, and the electronic device may control the widget to be displayed in different modes for different displaying states according to the height parameter, the width parameter and the playing frame rate, so as to meet various displaying requirements of the page.

In block 205, the electronic device terminates displaying the widget in the displaying state when detecting that the current time coincides with an effectiveness ending time.

The effective time further include an effectiveness ending time which corresponds to the effectiveness starting time and indicates the time when the displaying of the displaying state ends. The displaying of the displaying state starts at the effectiveness starting time and ends when the effectiveness ending time is up.

In an example, when the timer is started to record the current time, if it is detected that the current time coincides with the effectiveness starting time, the widget whose state is updated to the displaying state is displayed according to the content of the widget. During displaying the displaying state, the timer continues to record the current time. When the effectiveness ending time corresponding to the displaying state is up, the displaying of the widget in the displaying state is terminated. For example, if the effectiveness ending time of the displaying state A is March 18, 12 am, the electronic device may determine that the effectiveness ending time of the displaying state A is up and terminate the displaying of the widget in the displaying state A when it is detected that the current time is March 18, 12 am.

In the embodiment, the effective time includes the effectiveness starting time and the effectiveness ending time. The electronic device may control the starting time and ending time of the displaying state according to the effectiveness starting time and the effectiveness ending time corresponding to the displaying state, so as to flexibly control the widget to display in different displaying states within different time periods.

Alternatively, after terminating the displaying of the widget in the displaying state, the method may further include: determining another displaying state of the widget, and an effectiveness starting time of the another displaying state; generating content of the widget corresponding to the another displaying state according to a state parameter of the another displaying state in response to detecting that the current time reaches the effective time of the another displaying state; and displaying the widget having the state updated to the another displaying state according to the content of the widget corresponding to the another displaying state.

In some embodiments, the displaying control parameter may include state parameters of multiple displaying states and an effective time (effectiveness starting time and effectiveness ending time) of each displaying state. The different displaying states have different effectiveness starting time and different effectiveness ending time. The electronic device may display another displaying state after the currently displayed displaying state ends, such that flexible switching among multiple different displaying states can be achieved, thus meeting different displaying requirements of the page according to different displaying states.

In combination with the above examples, after the displaying of widget in the displaying state A is terminated, the electronic device may determine the displaying state whose effectiveness starting time is closest to the current time (March 18, 12 am) from the displaying state B and the displaying state C, i.e., the displaying state B is determined. The timer is started to record the current time, and when the current time reaches March 18, 1 pm, the electronic device generates the corresponding content of the widget according to the state parameter of the displaying state B, and displays the widget whose state is updated to the displaying state B according to the content of the widget. Regarding the process of displaying the widget whose state is updated to the displaying state B according to the state parameter of the displaying state B, reference can be made to the description with regard to the displaying state A, which is not explained here.

In summary, in the embodiment, the state parameter of the displaying state may include an image and/or a group of images (or a resource address), a height, a width, a playing frame rate or other parameters. If different displaying state include different images and/or different groups of images (or different resource addresses), the electronic device may adjust the content of the widget according to the image and/or the group of images (or the resource address). When different heights, different widths, different playing frame rates are used for different displaying states, the electronic device may adjust the height, the width and the playing frame rate during displaying the widget. By setting the state parameter, the widget can be displayed in different rates within different time periods, such that the displaying state of the widget can be adjusted flexibly, thus meeting different displaying requirements of the page.

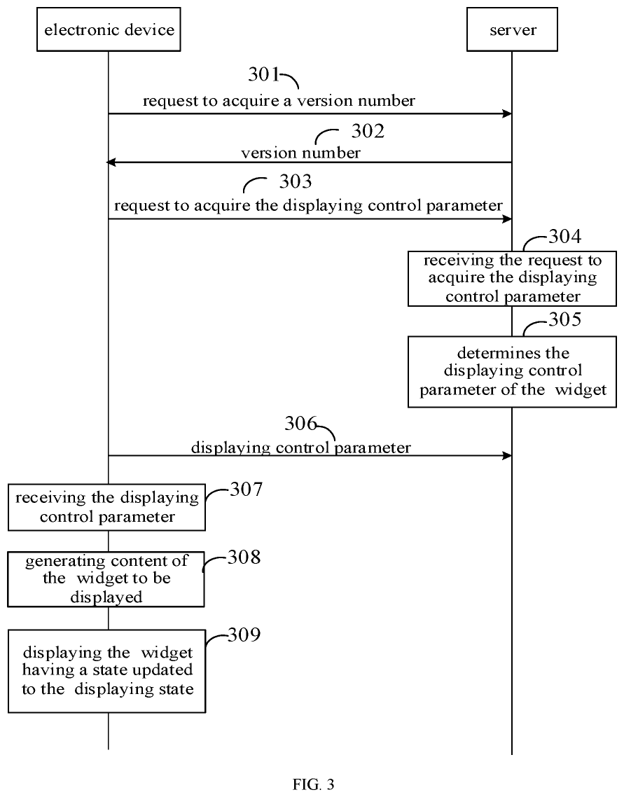

FIG. 3 is a schematic diagram illustrating a signaling interaction of a control method for displaying a widget according to an exemplary embodiment. As illustrated in FIG. 3, the method may include the followings.

In 301, an electronic device sends a request to acquire a version number to a server.

In 302, the server sends the version number of a displaying control parameter to the electronic device in response to the request to acquire the version number.

In 303, the electronic device sends a request to acquire the displaying control parameter when determining that the current acquired version number is different from a version number acquired last time.

In 304, the server receives the request to acquire the displaying control parameter from the electronic device.

The request to acquire the displaying control parameter includes a widget identification of a widget.

In 305, the server determines the displaying control parameter of the widget according to the widget identification of the widget.

In 306, the server sends the displaying control parameter to the electronic device.

In 307, the electronic device receives the displaying control parameter.

In 308, the electronic device generates content of the widget to be displayed according to a state parameter of a displaying state in response to detecting that a current time reaches an effective time of the displaying state.

In 309, the electronic device displays the widget having a state updated to the displaying state according to the content of the widget.

Regarding details of 301-309, reference can be made to the action in block 201, which is not explained here.

In summary, the electronic device acquires the displaying control parameter of the widget on the page, generates content of the widget according to the state parameter of the displaying state in response to detecting that the current time reaches the effective time corresponding to the displaying state, and displays the widget having a state updated to the displaying state according to the content of the widget. In this way, it is unnecessary to re-develop the widgets, and different displaying requirements can be met by flexibly controlling the displayed content of the widget, such that an efficiency of displaying the widget can be improved, in particularly adaptable to the application scenario having huge different displaying requirements or frequently changed displaying requirements.

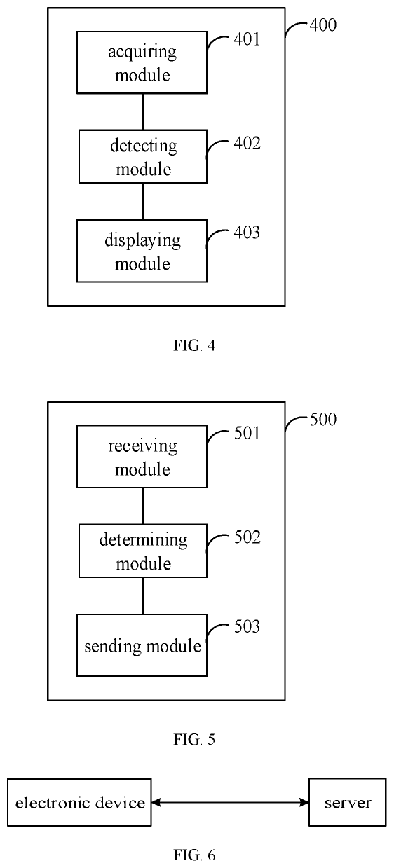

FIG. 4 is a block diagram illustrating a control apparatus for displaying a widget according to an exemplary embodiment. The apparatus 400 may include an acquiring module 401, a detecting module 402 and a displaying module 403.

The acquiring module 401 is configured to acquire a displaying control parameter of a widget on a page, the displaying control parameter including a state parameter of a displaying state, and an effective time corresponding to the displaying state.

The detecting module 402 is configured to generate content of the widget according to the state parameter of the displaying state in response to detecting that a current time reaches the effective time corresponding to the displaying state.

The displaying module 403 is configured to display the widget having a state updated to the displaying state according to the content of the widget.

Alternatively, the effective time includes an effectiveness starting time.

The detecting module 402 is configured to: start a timer to record a current time; determine that the current time reaches the effectiveness starting time and generate the content of the widget according to the state parameter of the displaying state, in response to detecting that the current time coincides with the effectiveness starting time.

Alternatively, the effective time includes an effectiveness ending time.

After displaying the widget having a state updated to the displaying state according to the content of the widget, the displaying module 403 is further configured to terminate displaying of the widget in the displaying state in response to detecting that the current time coincides with the effectiveness ending time.

Alternatively, the apparatus further includes a determining module.

The determining module is configured to determine a further displaying state of the widget and an effectiveness starting time of the further displaying state.

The detecting module 402 is further configured to generate content of the widget corresponding to the further displaying state according to a state parameter of the further displaying state in response to detecting that the current time reaches the effective time of the further displaying state.

The displaying module 403 is further configured to display the widget having the state updated to the further displaying state according to the content of the widget corresponding to the further displaying state.

Alternatively, the state parameter includes an image and/or a group of images corresponding to the displaying state.

The detecting module 402 is configured to determine the image and/or the group of images from the state parameter of the displaying state as the content of the widget.

Alternatively, the state parameter includes a resource address corresponding to the displaying state.

The detecting module 402 is configured acquire an image and/or a group of images corresponding to the displaying state as the content of the widget according to the resource address.

Alternatively, the state parameter includes a displaying identification.

The displaying module 403 includes a first displaying unit or a second displaying unit.

The first displaying unit is configured to display the widget having the state updated to the displaying state according to an image when the image is determined to be displayed according to the displaying identification.

The second displaying unit is configured to display the widget having the state updated to the displaying state according to images in a group of images when the images in the group of images are determined to be displayed according to the displaying identification.

Alternatively, the state parameter further includes a height parameter and a width parameter of the widget.

The first displaying unit is configured to: render the image and display the rendered image in a displaying page of the widget according to the height parameter and the width parameter.

Alternatively, the state parameter further includes a height parameter and a width parameter of the widget, and a playing frame rate of the group of images.

The second displaying unit is configured to: render the images in the group of images and display the rendered images in sequence in a displaying page of the widget according to the height parameter, the width parameter and the playing frame rate.

Alternatively, the acquiring module 401 is configured to acquire the displaying control parameter from a server periodically.

Alternatively, the acquiring module 401 is configured to acquire a version number of the displaying control parameter from the server periodically; and acquire the displaying control parameter from the server in a case that the version number acquired currently is different from a version number acquired last time.

In summary, in the embodiment, the displaying control parameter of the widget on the page is acquired, the content of the widget is generated according to the state parameter of the displaying state in response to detecting that the current time reaches the effective time of the displaying state, and the widget having the state updated to the displaying state is displayed according the content of the widget. In this way, it is unnecessary to re-develop the widgets, and different displaying requirements can be met by flexibly controlling the displayed content of the widget, such that an efficiency of displaying the widget can be improved, in particularly adaptable to the application scenario having huge different displaying requirements or frequently changed displaying requirements.

FIG. 5 is a block diagram illustrating a control apparatus for displaying a widget according to another exemplary embodiment. The apparatus 500 may include a receiving module 501, a determining module 502 and a sending module 503.

The receiving module 501 is configured to receive a first request to acquire a displaying control parameter from an electronic device, the first request including a widget identification of a widget.

The determining module 502 is configured to determine the displaying control parameter of the widget according to the widget identification, the displaying control parameter including a state parameter of a first displaying state, and an effective time corresponding to the first displaying state.

The sending module 503 is configured to send the displaying control parameter to the electronic device.

Alternatively, the receiving module 501 is configured to receive a second request to acquire a version number from the electronic device.

The sending module 503 is configured to send the version number of the displaying control parameter to the electronic device in response to the second request, such that the electronic device sends the first request in a case that the version number acquired currently is different from a version number acquired last time.

FIG. 6 is a block diagram illustrating a control system for displaying a widget according to an exemplary embodiment. The system includes an electronic device and a server.

The electronic device is configured to perform the method implemented by an electronic device in the embodiments described with reference to FIG. 1-FIG. 3.

The server is configured to perform the method implemented by a server in the embodiments described with reference to FIG. 3.

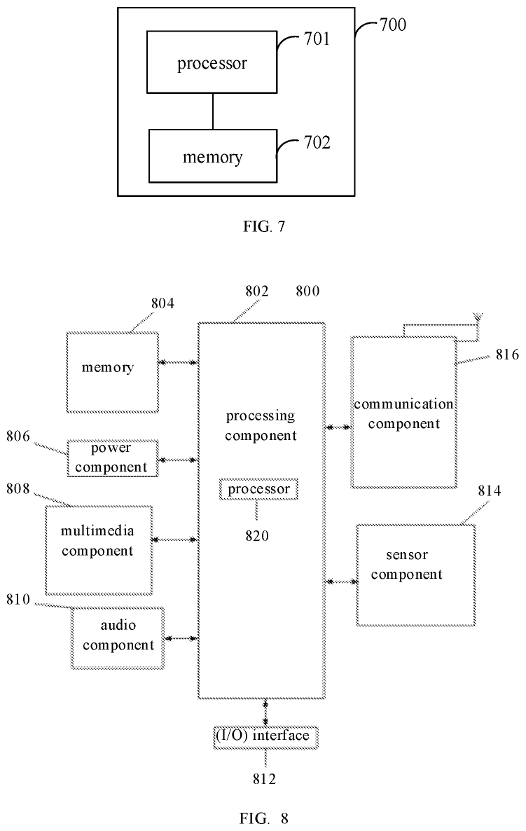

FIG. 7 is a block diagram illustrating an electronic device according to an exemplary embodiment. The electronic device 700 may include a processor 701, and a memory 702 configured to store instructions executable by the processor 701. The processor 701 is configured to execute the instructions to implement the method in the embodiments described with reference to FIG. 1-FIG. 3.

In an exemplary embodiment, a non-transitory computer-readable storage medium is provided. When instructions in the storage medium are executed by a processor of an electronic device, cause the electronic device to perform the method implemented by an electronic device in the embodiments described with reference to FIG. 1-FIG. 3.

When instructions in the storage medium are executed by a processor of a server, cause the server to perform the method implemented by a server in the embodiments described with reference to FIG. 3.

In an exemplary embodiment, a computer program product is provided.

When the computer program product runs on an electronic device, cause the electronic device to perform the method implemented by an electronic device in the embodiments described with reference to FIG. 1-FIG. 3.

When the computer program product runs on a server, causes the server to perform the method implemented by a server in the embodiments described with reference to FIG. 3.

FIG. 8 is a block diagram illustrating a control apparatus for displaying a widget according to a still exemplary embodiment. The apparatus 800 may include one or more of the following components: a processing component 802, a memory 804, a power component 806, a multimedia component 808, an audio component 810, an input/output (I/O) interface 813, a sensor component 814, and a communication component 816.

The processing component 802 typically controls overall operations of the apparatus 800, such as the operations associated with display, telephone calls, data communications, camera operations, and recording operations. The processing component 802 may include one or more processors 820 to execute instructions to perform all or part of the steps in the above described methods. Moreover, the processing component 802 may include one or more modules which facilitate the interaction between the processing component 802 and other components. For instance, the processing component 802 may include a multimedia module to facilitate the interaction between the multimedia component 808 and the processing component 802.

The memory 804 is configured to store various types of data to support the operation of the apparatus 800. Examples of such data include instructions for any applications or methods operated on the apparatus 800, contact data, phonebook data, messages, pictures, video, etc. The memory 804 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 806 provides power to various components of the apparatus 800. The power component 806 may include a power management system, one or more power sources, and any other components associated with the generation, management, and distribution of power in the apparatus 800.

The multimedia component 808 includes a screen providing an output interface between the apparatus 800 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 808 includes a front-facing camera and/or a rear-facing camera. When the apparatus 800 is in an operating mode, such as a shooting mode or a video mode, the front-facing camera and/or the rear-facing camera can receive external multimedia data. Each front-facing camera and rear-facing camera may be a fixed optical lens system or has focal length and optical zoom capability.

The audio component 810 is configured to output and/or input audio signals. For example, the audio component 810 includes a microphone (“MIC”) configured to receive an external audio signal when the apparatus 800 is in an operation mode, such as a call mode, a recording mode, and a voice recognition mode. The received audio signal may be further stored in the memory 804 or transmitted via the communication component 816. In some embodiments, the audio component 810 further includes a speaker to output audio signals.

The I/O interface 813 provides an interface between the processing component 802 and peripheral interface modules, such as a keyboard, a click wheel, buttons, and the like. The buttons may include, but are not limited to, a home button, a volume button, a starting button, and a locking button.

The sensor component 814 includes one or more sensors to provide status assessments of various aspects of the apparatus 800. For instance, the sensor component 814 may detect an open/closed status of the apparatus 800, relative positioning of components, e.g., the display and the keypad, of the apparatus 800, a change in position of the apparatus 800 or a component of the apparatus 800, a presence or absence of user contact with the apparatus 800, an orientation or an acceleration/deceleration of the apparatus 800, and a change in temperature of the apparatus 800. The sensor component 814 may include a proximity sensor configured to detect the presence of nearby objects without any physical contact. The sensor component 814 may also include a light sensor, such as a CMOS or CCD image sensor, for use in imaging applications. In some embodiments, the sensor component 814 may also include an accelerometer sensor, a gyroscope sensor, a magnetic sensor, a pressure sensor, or a temperature sensor.

The communication component 816 is configured to facilitate communication, wired or wirelessly, between the apparatus 800 and other devices. The apparatus 800 can access a wireless network based on a communication standard, such as WiFi, 2G, or 3G, or a combination thereof. In one exemplary embodiment, the communication component 816 receives a broadcast signal or broadcast associated information from an external broadcast management system via a broadcast channel. In one exemplary embodiment, the communication component 816 further includes a near field communication (NFC) module to facilitate short-range communications. For example, the NFC module may be implemented based on a radio frequency identity (RFID) technology, an infrared data association (IrDA) technology, an ultra-wideband (UWB) technology, a Bluetooth (BT) technology, and other technologies.

In exemplary embodiments, the apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer readable storage medium including instructions, such as included in the memory 804, executable by the processor 820 in the apparatus 800, for performing the above-described methods. For example, the non-transitory computer-readable storage medium may be a ROM, a RAM, a CD-ROM, a magnetic tape, a floppy disc, an optical data storage device, and the like.

The above embodiments may be realized by hardware, software, firmware or combinations thereof partly or wholly. When the embodiments are realized by software, they can be realized in a form of a computer program product partly or wholly.

The computer program product includes one or more computer instructions. When the computer instructions are loaded and executed on a computer, the process or functionality according to the embodiments of the disclosure is generated partly or wholly. The computer may be a general purpose computer, a dedicated computer, a computer network, or other programmable device. The computer instructions may be stored in a computer-readable storage medium, or transmitted from a computer-readable storage medium to another computer-readable storage medium. For example, the computer instructions can be transmitted from a network station, a computer, a server or a data center to another network station, another computer, another server or another data center via wired communication (for example, coaxial cable, optical fiber, digital subscriber line (DSL)) or wireless communication (for example, infrared, wireless, microware). The computer-readable storage medium may be any available medium that can be stored by the computer, or may be a data storage device including a server integrated by one or more available mediums, a data center or the like. The available medium may be a magnetic medium (for example, floppy disk, hard disk, and magnetic tape), an optical medium (for example DVD) or semiconductor medium (for example solid state disk (SSD)) or the like.

Those skilled in the art can understand clearly that, for ease and simple of description, regarding the specific working processes of the above system, apparatus and units, reference can be made to the aforementioned embodiments, which are not explained herein.

It should be understood that, the apparatus disclosed in several embodiments provided by the present disclosure can be realized in any other manner. For example, the apparatus embodiments described above can be merely exemplary, for example, the units are just divided according to logic functions. In practical implementation, the units can be divided in other manners, for example, multiple units or components can be combined or integrated into another system, or some features can be omitted or not executed. In addition, the mutual coupling or direct coupling or communication connection described or discussed can be via some interfaces, and indirect coupling or communication connection between devices or units may be electrical, mechanical or of other forms.

The units illustrated as separate components can be or not be separated physically, and components described as units can be or not be physical units, i.e., can be located at one place, or can be distributed onto multiple network units. It is possible to select some or all of the units according to actual needs, for realizing the objective of embodiments of the present disclosure.

In addition, respective functional units in respective embodiments of the present disclosure can be integrated into one processing unit, or can be present as separate physical entities. It is also possible that two or more than two units are integrated into one unit. The integrated units may be implemented in form of hardware, or in form of functional software units.

If the integrated unit is implemented in form of functional software units and are sold or used as separate products, it can be stored in a computer readable storage medium. Based on this understanding, the parts of the technical solutions or the essential parts of the technical solutions (i.e. the parts making a contribution to the related art) can be embodied in form of software product, which is stored in a storage medium, and includes several instruction used for causing a computer device (for example, a personal computer, a server or a network device) to execute all or part of steps in the methods described in respective embodiments of the present disclosure. The above storage medium may be any medium capable of storing program codes, including a USB flash disk, a mobile hard disk, a Read-Only Memory (ROM), a Random Access Memory (RAM), a disc, or an optical disk.

Since the apparatus embodiments are substantially similar to the method embodiments, the apparatus embodiments are not described in detail, and regarding the relevant content, reference can be made to the method embodiments.

Those skilled in the art may easily conceive of other embodiments of the present disclosure by considering the description and practicing the disclosure disclosed herein. This disclosure is intended to cover any variations, uses, or adaptive changes that follow the general principles of this disclosure and include common general knowledge or customary technical means in the technical field not disclosed in this disclosure. The description and examples are to be considered exemplary only, and the true scope and spirit of this disclosure are disclosed by the claims.

It should be understood that the present disclosure is not limited to the precise structure that has been described above and shown in the drawings, and various modifications and changes can be made without departing from the scope thereof. The scope of the present disclosure is limited only by the appended claims.

What is claimed is:

1. A method for displaying a widget, comprising:
acquiring a displaying control parameter of a widget on a page, wherein the displaying control parameter comprises a state parameter of a displaying state of the widget and an effective time corresponding to the displaying state;
generating content of the widget based on the state parameter in response to detecting a current time reaches the effective time; and
displaying the widget in the displaying state based on the content.

2. The method of claim 1, wherein the displaying control parameter comprises state parameters of a plurality of displaying states of the widget and respective effective time of the plurality of displaying states;
said generating content of the widget based on the state parameter in response to detecting a current time reaches the effective time comprising:
generating the content of the widget based on the state parameter of one displaying state in the plurality of displaying states in response to detecting the current time reaches the respective effective time of the displaying state.

3. The method of claim 1, said generating content of the widget based on the state parameter comprising:
acquiring an image or a group of images corresponding to the displaying state based on the state parameter; and
determining the image or the group of images as the content.

4. The method of claim 3, said acquiring an image or a group of images corresponding to the displaying state based on the state parameter comprising:
acquiring the image or the group of images based on a resource address included in the state parameter.

5. The method of claim 3, said displaying the widget in the displaying state based on the content comprising:
displaying the widget in the displaying state based on the image corresponding to the displaying state or an image from the group corresponding to a displaying identification indicating to display one image included in the state parameter; and
displaying the widget in the displaying state based on more than one images from the group corresponding to the displaying identification indicating to display more than one image included in the state parameter.

6. The method of claim 5,
said displaying the widget in the displaying state based on the image corresponding to the displaying state or an image from the group comprising:
rendering the image; and
displaying the image in a displaying page of the widget based on a height parameter and a width parameter included in the state parameter.

7. The method of claim 5,
said displaying the widget in the displaying state based on more than one images from the group comprising:
rendering the more than one images; and
displaying the more than one images in sequence based on a playing frame rate included in the state parameter in a displaying page of the widget based on a height parameter and a width parameter included in the state parameter.

8. An electronic device, comprising:
one or more processors;
one or more memories configured to store instructions executable by the one or more processors;
wherein the one or more processors are configured to execute the instructions to perform a method for displaying a widget, comprising:
acquiring a displaying control parameter of a widget on a page, wherein the displaying control parameter comprises a state parameter of a displaying state of the widget and an effective time corresponding to the displaying state;
generating content of the widget based on the state parameter in response to detecting a current time reaches the effective time; and
displaying the widget in the displaying state based on the content.

9. The electronic device of claim 8, wherein the displaying control parameter comprises state parameters of a plurality of displaying states of the widget and respective effective time of the plurality of displaying states;
said generating content of the widget based on the state parameter in response to detecting a current time reaches the effective time comprising:
generating the content of the widget based on the state parameter of one displaying state in the plurality of displaying states in response to detecting the current time reaches the respective effective time of the displaying state.

10. The electronic device of claim 8, said generating content of the widget based on the state parameter comprising:
acquiring an image or a group of images corresponding to the displaying state based on the state parameter; and
determining the image or the group of images as the content.

11. The electronic device of claim 10, said acquiring an image or a group of images corresponding to the displaying state based on the state parameter comprising:
acquiring the image or the group of images based on a resource address included in the state parameter.

12. The electronic device of claim 10, said displaying the widget in the displaying state based on the content comprising:
displaying the widget in the displaying state based on the image corresponding to the displaying state or an image from the group corresponding to a displaying identification indicating to display one image included in the state parameter; and
displaying the widget in the displaying state based on more than one images from the group corresponding to the displaying identification indicating to display more than one image included in the state parameter.

13. The electronic device of claim 12,
said displaying the widget in the displaying state based on the image corresponding to the displaying state or an image from the group comprising:
rendering the image; and
displaying the image in a displaying page of the widget based on a height parameter and a width parameter included in the state parameter.

14. The electronic device of claim 12,
said displaying the widget in the displaying state based on more than one images from the group comprising:
rendering the more than one images; and
displaying the more than one images in sequence based on a playing frame rate included in the state parameter in a displaying page of the widget based on a height parameter and a width parameter included in the state parameter.

15. A system, comprising:
an electronic device comprising one or more processors and one or more memories configured to store instructions executable by the one or more processors, wherein the one or more processors are configured to execute the instructions to perform operations comprising: acquiring a displaying control parameter of a widget on a page, wherein the displaying control parameter comprises a state parameter of a displaying state of the widget and an effective time corresponding to the displaying state generating content of the widget based on the state parameter in response to detecting a current time reaches the effective time; and displaying the widget in the displaying state based on the content; and
a server comprising one or more processors and one or more memories configured to store instructions executable by the one or more processors, wherein the one or more processors are configured to execute the instructions to perform operations comprising: receiving a first request to acquire a displaying control parameter from an electronic device, wherein the first request comprises a widget identification of a widget; determining the displaying control parameter of the widget based on the widget identification, wherein the displaying control parameter comprises a state parameter of a displaying state of the widget and an effective time corresponding to the displaying state; and sending the displaying control parameter to the electronic device.

16. The system of claim 15, wherein the one or more processors of the server are further configured to perform operations:
receiving a second request to acquire a version number of the displaying control parameter from the electronic device; and
sending the version number to the electronic device in response to the second request, such that the electronic device sends the first request in a case that the version number acquired currently is different from a version number acquired last time.

17. The system of claim 15, wherein the displaying control parameter comprises state parameters of a plurality of displaying states of the widget and respective effective time of the plurality of displaying states;
said generating content of the widget based on the state parameter in response to detecting a current time reaches the effective time comprising:
generating the content of the widget based on the state parameter of one displaying state in the plurality of displaying states in response to detecting the current time reaches the respective effective time of the displaying state.

18. The system of claim 15, said generating content of the widget based on the state parameter comprising:
acquiring an image or a group of images corresponding to the displaying state based on the state parameter; and
determining the image or the group of images as the content.

19. The system of claim 18, said acquiring an image or a group of images corresponding to the displaying state based on the state parameter comprising:
acquiring the image or the group of images based on a resource address included in the state parameter.

20. The system of claim 18, said displaying the widget in the displaying state based on the content comprising:
displaying the widget in the displaying state based on the image corresponding to the displaying state or an image from the group corresponding to a displaying identification indicating to display one image included in the state parameter; and
displaying the widget in the displaying state based on more than one images from the group corresponding to the displaying identification indicating to display more than one image included in the state parameter.
